(19) United States
(12) Patent Application Publication
(10) Pub. No.: US 2026/0186166 A1
(43) Pub. Date: Jul. 2, 2026

(54) NEURAL GENERAL CIRCULATION MODELS

(71) Applicant: Google LLC, Mountain View, CA (US)

(72) Inventors: Stephan Owen Steele Hoyer, San Francisco, CA (US); Dmitrii Kochkov, Cambridge, MA (US); Ian Langmore, Millbrae, CA (US); Janni Yuval, Cambridge, MA (US); Griffin Stuart Mooers, Cambridge, MA (US); Peter Christian Norgaard, Mountain View, CA (US); Jamie Alexander Smith, Mountain View, CA (US); Michael Phillip Brenner, Somerville, MA (US)

(21) Appl. No.: 18/856,191

(22) PCT Filed: Oct. 18, 2023
(86) PCT No.: PCT/US2023/035420

§ 371 Date: Oct. 11, 2024

(51) Int. Cl. G01W 1/10; G06N 3/0455

(52) U.S. Cl. CPC G01W 1/10; G06N 3/0455

(57) ABSTRACT

Methods, systems, and apparatus, including computer programs encoded on a computer storage medium, for emulating the evolution of meteorological phenomena within a weather system. In one aspect, a system comprises receiving observation data characterizing an initial state of a weather system at a first time step, encoding the initial state as an observation representation, updating the observation representation for each of a sequence of time steps, the updating comprising: calculating one or more dynamical tendencies for the weather system using a numerical solver, processing an input comprising the observation representation using a physical tendency neural network to generate one or more physical tendencies for the weather system, combining the observation representation with the one or more dynamical and physical tendencies to update the observation, and decoding the observation representation to generate a predicted observation of a future weather state at the final time step of the sequence of time steps.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification describes a hybrid weather emulation system implemented as computer programs on one or more computers in one or more locations for processing an initial observation of a weather system, emulating the evolution of meteorological phenomena with the weather system, and generating a predicted future weather observation, e.g., a forecast of the weather state within the system at a future time.

In this specification, a weather system refers to the atmosphere or a section of the atmosphere, e.g., the atmosphere of a localized geographic area, and the weather within the weather system refers to the meteorological phenomena occurring in the atmosphere at a particular place and time. As an example, meteorological phenomena can include precipitation, wind, and temperature, and these and other meteorological phenomena can be characterized by data quantifying air pressure, water vapor, specific heat, and so on, within the weather system to characterize the weather system's current state at a particular place and time.

In numerical weather forecasting and climate prediction modeling, e.g., extremely long-range weather forecasting, general circulation models are a type of forward model that can be used to evolve a weather system from an initial state to a future state forward in time by iteratively updating the state of the weather system. In particular, this specification describes techniques the hybrid weather emulation system can implement for receiving observation data characterizing the initial state of the weather system at a first time step and processing the data using a neural general circulation model to update the weather system over a sequence of time steps in order to generate a predicted future weather observation that characterizes a final state of the weather system.

The neural general circulation model described in this specification is a hybrid evolution model that combines a numerical general circulation model with machine learning, e.g., one or more neural network models, for weather emulation to provide a forecast that accounts for both large and small-scale (e.g., more localized) meteorological phenomena. More specifically, the hybrid evolution model includes a numerical solver that solves the primitive equations of the atmosphere under the hydrostatic approximation, a set of equations that define the atmosphere's basic dynamics, to calculate one or more dynamical tendencies of the weather system, i.e., the effects of fluid motion, thermodynamics, and the Coriolis force on these values; and a physical tendency neural network to generate one or more physical tendencies of the weather system that are not captured by the primitive equations, e.g., the effects of convection, solar radiation, precipitation, clouds, and sub-grid dynamics. In this specification, the tendencies output by the model are defined to be the gradient, e.g., the change over a time step, of data values that characterize the weather system's state at a given point in time. The model can then update the current state of the weather system in model-space at each time step using an integrator to integrate the dynamical and physical tendencies with the most recent weather state.

Particular embodiments of the subject matter described in this specification can be implemented so as to realize one or more of the following advantages.

The techniques of this specification describe an end-to-end computer-implemented hybrid weather emulation system for processing observation data to accurately forecast future states of a weather system. The hybrid system can evolve the weather system forward in time using a neural general circulation model that unifies a numerical and machine learning approach to robustly emulate both large- and small-scale meteorological phenomena at each time step in order to generate a more accurate final observation than a purely numerical or purely machine learning approach can provide alone. More specifically, the hybrid weather emulation system can overcome the drawbacks of both approaches by leveraging their respective advantages in a unified approach that is numerically stable.

For example, pure numerical models that solve the primitive equations cannot accurately model meteorological phenomena such as clouds, solar radiation, gravity wave drag, and precipitation, since resolving these processes would require simulations with prohibitively expensive grid resolution, e.g., fine scales less than 100 m. Instead, pure numerical models approximate the effect of these smaller-scale processes using approximate parameterizations, which have insufficient accuracy.

Additionally, pure machine learning weather prediction models can incorrectly learn relationships that violate geographic-causality since they are not guaranteed to be physically consistent, e.g., satisfy conservation of mass, momentum, and energy. However, numerical methods are guaranteed to satisfy physical consistency across large-scales and machine learning models can emulate meteorological phenomena with high fidelity in a localized region.

In particular, the hybrid weather emulation system described can emulate large- and small-scale meteorological phenomena by separately calculating dynamical tendencies with a numerical solver and generating localized physical tendencies with a physical tendency neural network in a unified neural general circulation model. In particular, separating and then integrating the large- and small-scale meteorological phenomena can enable effective tracking of the evolution of the weather system at each time step by more precisely emulating meteorological phenomena at different geographic length-scales at each time step, thereby increasing the accuracy of the final predicted weather state, e.g., since small deviations can accumulate over time and drastically amplify the deviation from desired behavior in a forward model.

Additionally, the built-in separation increases the interpretability of the model by clearly discriminating between dynamical and physical processes. The separation also increases the ease of compatibility for potential integration with existing numerical weather prediction systems. In particular, this modularization can allow the opportunity to easily integrate parts of the model, e.g., the physical tendency neural network with existing numerical weather prediction codebases by replacing the sections of the codebase that pertain to numerically solving computationally-expensive physics parameterization calculations.

Furthermore, this specification introduces a novel end-to-end method for training the neural general circulation model over increasingly long rollouts. In this specification, a rollout parametrizes the number of model evolution time steps within each model training time step. In particular, the end-to-end training technique involves training the neural general circulation model over shorter rollouts, evaluating model performance, and gradually increasing the length of the rollout as the model learns. In particular, training over increasingly long rollouts can reduce both computational resources and training time by ensuring the model's training corresponds with the model's learning, e.g., the model can be trained more frequently when it is less accurate and less frequently as the model learns. Additionally, training over increasingly long rollouts can ensure that the model is penalized for small deviations, e.g., deviations that can amplify over time in a forward model, more frequently earlier on, and is only allowed to run forward in time for a longer rollout when the model is deemed to generate accurate enough results to be able to be evaluated on the longer rollout.

This specification also describes techniques for training the neural general circulation model with a variety of physics-inspired loss terms that can be applied across both large- and small-scale atmospheric features in both nodal (longitude-latitude) and spectral (spherical-harmonic) bases. In particular, these losses can be calculated in both an observation and a model space to ensure the model emulates the weather state with high-fidelity in both spaces.

Assessing model performance using physics-based loss terms can mitigate the issue of nonphysical phenomena arising from vanilla loss functions, which encourage average results that are oversmoothed for weather applications. In contrast, the physics-inspired losses described can yield a model that generates realistic looking predictions with the expected variability and extremes of a weather system, even when running the model forward in time over decades. The physics-inspired loss terms can also result in lower error than state-of-the-art weather prediction systems, especially for predicting three-dimensional atmospheric variables, such as temperature, specific humidity, and the horizontal and vertical transport velocities multiple days in advance.

In particular, the neural general circulation model of this specification can generate sharp predictions at long lead-times, e.g., after being run forward in time many time steps. More specifically, the model can accurately predict large-scale meteorological phenomena such as seasonal temperature cycles, the generation of tropical cyclones, and monsoon wind reversal. In results from an example implementation discussed herein, the model can replicate observed global temperature trends over 35 years from 1980 to 2015 with high fidelity over a range of time-scales, from several hours to several weeks.

Additionally, the hybrid weather emulation system can successfully generate future weather state observation predictions at much greater resolution than currently implemented state-of-the-art weather prediction models within the same computational time, thereby reducing the use of computational resources. In particular, the system described can be configured to run efficiently on accelerator hardware, such as GPUs (graphic processing units) and TPUs (tensor processing units). Leveraging accelerators can enable much more efficient weather predictions than current state-of-the-art weather prediction systems, which require supercomputers to execute upwards of one million lines of code on traditional CPUs (computer processing units). For example, the neural general circulation model can generate a 10-day weather forecast in 10 seconds on one TPU, representing a speed-up of 100× in wall-clock time from a traditional numerical weather prediction model, which can take an average of one hour on 10,000 CPU cores to compute the 10-day weather forecast.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a system diagram of an example hybrid weather emulation system.

FIG. 2 depicts an example neural general circulation model that can be integrated into the hybrid weather emulation system of FIG. 1.

FIG. 3 depicts an example physical tendency neural network model.

FIG. 4 demonstrates how the learned physical tendencies of the physical tendency neural network model can be combined with stochastic physics tendencies before being integrated with dynamical tendencies to advance the weather system forward in time.

FIG. 5 depicts example observation space and model space loss schemes that can be used separately or combined to train the neural general circulation model on a variety of physics-based losses.

FIG. 6 illustrates a training technique for increasing rollout length over the course of training the neural general circulation model.

FIG. 7 depicts the results of an example neural general circulation model trained at different resolutions.

FIG. 8 depicts results of an example model trained to predict weather state data values at varying lead-times.

FIG. 9 is a flow chart of an example process for generating a predicted observation of a future weather state.

FIG. 10 is a flow chart of an example process for iteratively updating the observation to evolve the weather state forward in time.

Like reference numbers and designations in the various drawings indicate like elements.

### DETAILED DESCRIPTION

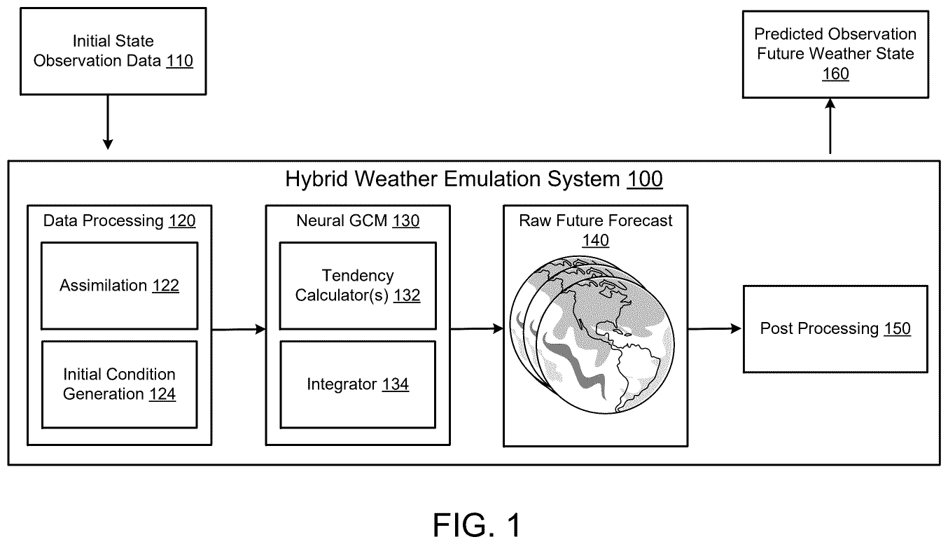

FIG. 1 shows an example hybrid weather emulation system 100. The hybrid weather emulation system 100 is an example of a system implemented as computer programs on one or more computers in one or more locations in which the systems, components, and techniques described below are implemented.

In particular, the hybrid weather emulation system 100 can receive and process observation data 110 of a weather system using a neural general circulation model (GCM) 130 to predict an observation of the future weather state 160 of the weather system.

As an example, the observation data 110 can be a raw observation of the weather state of the system, e.g., an observation from a satellite, weather station, or weather buoy that has not been cleaned or wrangled into a useful format. As another example, the observation data 110 can be derived from a simulation of the weather system. As yet another example, the observation data 110 can come from previous historical data from a satellite, weather station, or weather buoy, in which case the observation data 110 can be either raw or preprocessed.

In particular, the observation data 110 can include data that characterizes the weather system's current state. As an example, the observation data 110 can include the horizontal and vertical transport velocities, air density over the oceans, incident solar radiation, near-infrared albedo, mean evaporation rate, and turbulent surface stress. As another example, the observation data 110 can include sea surface temperature, sea ice observations, and total incident solar radiation.

The predicted observation future weather state 160 can be characterized by the same values as the observation data 110 at a future time. More specifically, the predicted observation future weather state 160 provides updated values for the weather system that can be used for different purposes depending on how far into the future (with respect to the time associated with the initial state observation data 110) the future time is. Examples of not-so-distant, distant, and extremely distant future predicted observations 160 and their respective uses will be described with more detail below.

In some cases, the hybrid weather emulation system 100 can generate the predicted future weather state 160 for a time in the not-so-distant future, e.g., one hour, one day, one week, or 20 days in the future. In this case, the weather system prediction provides either a short or medium-range weather forecast. As an example, the short or medium-range weather forecast can be delivered by newscasters or provided via a weather application to users of the application to inform decisions such as what to wear, where to go, etc. Additionally, the short or medium-range weather forecasts can be used to protect lives and property in the event of severe weather.

In another case, the system 100 can generate the predicted future weather state 160 in the distant future, e.g., 3 months, 6 months, or one year. In this case, the weather system prediction provides a long-range weather forecast and can be used to provide planning information to water resource management, agriculture, transportation, urban planning, and insurance organizations to better inform decisions. As an example, the long-range weather forecast can include El Niño and La Niña forecasts and can be used to inform farmers (and also commodities markets) of future crop conditions. As another example, the long-range weather forecast can notify humanitarian organizations of projected natural disasters or famine conditions arising from months-long lack of prolonged rain.

In yet another case, the system 100 can generate the predicted future weather state 160 for a time in the extremely distant future, e.g., 10 years, 20 years, or 200 years from the initial weather observation 110. In this case, the weather system prediction provides a climate prediction. As an example, the climate prediction can be used to understand how to prepare for future climate scenarios, such as scenarios based on the level of projected greenhouse gasses in the atmosphere, and can be used to more accurately estimate human population, availability of food and useable land, etc. in the future. As another example, the system 100 can start with an initial observation 110 that represents a “current state” from the very distant past and run forward in time to generate a predicted future weather state 160 in the not-so-distant past that can help improve overall understanding of past climate evolution and inform understanding of future climate developments.

After receiving the historical observation data 110, the system can process the historical observation data 110 in a data processing module 120 in accordance with whether or not the observation data 110 has already been processed, partially processed, or remains raw, e.g., data taken directly from a satellite, weather station, or weather buoy.

In particular, the data processing 120 can optionally include one or more of assimilation 122 and initial condition generation 124 depending on whether or not the observation data has been previously preprocessed or partially preprocessed.

In the case that the observation data 110 is derived from a simulation of the weather system, the system can perform assimilation 122 to combine previous simulated forecast data for the weather system with received historical observation data 110. In particular, assimilation 122 can produce a new more precise estimate of the weather state at a point in time. As an example, the system can combine previous simulated forecasts with actual observations every 6, 12, or 24 hours to improve the quality of data.

The data processing 120 can also include the generation of initial conditions 124 for the weather system. In this case, generating the initial conditions 124 can involve generating the data input for the neural general circulation model 130. In particular, generating initial conditions 124 parametrizes the weather system at time t=0, e.g., at the start of the first time step within the sequence of time steps that defines the weather system's evolution.

As an example, generating initial conditions 124 can involve defining a gridded system within the weather system, e.g., defining a number of localized points to correspond with three-dimensional boxes that depend on a parameter specifying the coarseness of the grid system, and assigning an initial data vector for each box using the assimilated data. More specifically, the system can employ a number of discretization techniques to create the grid and assign initial conditions 124. As an example, any one of pseudo-spectral spatial, semi-Lagrangian, finite volumes, discontinuous Galerkin, Voronoi tessellations, terrain-following coordinate, etc, methods can be used to define the grid system used for generating the initial conditions 124.

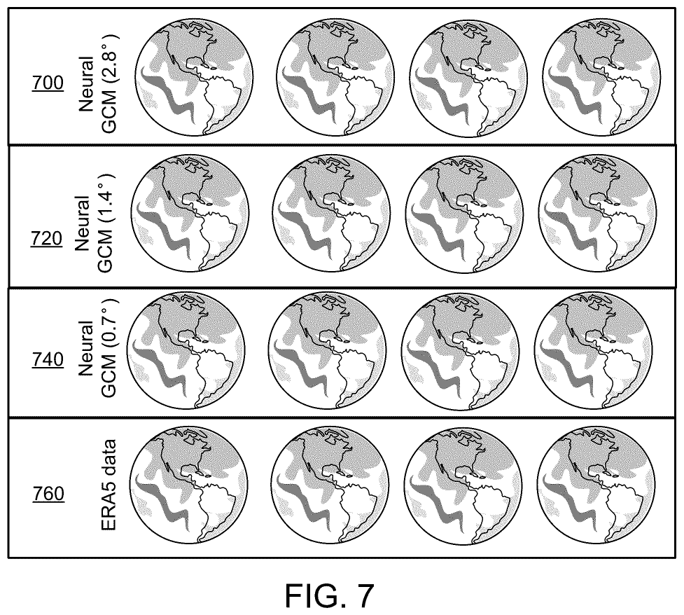

In some cases, the resolution of the discretized weather system can be parametrized by a coarseness parameter. In this case, the resolution of the predicted observation 160 depends on the coarseness of the chosen grid-system in initial condition generation 124. e.g., parametrizing fine-mesh grids can allow for more precise calculations than parametrizing larger three-dimensional boxes. As an example, the coarseness parameter can be defined to balance the tradeoff between grid-size and the resources needed for computation, e.g., the parameter can be set to optimize for the desired precision of the final predicted observation of the future weather state 160 with available computational resources. An example of the impact of the chosen grid-size on result precision for an example hybrid weather emulation system will be covered in more detail with respect to FIG. 7.

As an example, the observation data 110 can come from a preprocessed dataset, such as from the ERA5 reanalysis dataset, the ECMWF's (European Centre for Medium-Range Weather Forecast) fifth generation atmospheric reanalysis of the global climate. More specifically, reanalysis involves assimilation, e.g., augmenting simulation data with real observations. In the case that the system receives ERA5 data as the observation data 110, the system 100 can skip the assimilation 122 step in data processing 120, since the data has already been assimilated. Additionally, the ERA5 dataset is pre-gridded, and, in some examples, initial conditions 124 can be assigned in accordance with the pre-existing grid system. In other examples, the system 100 can regrid the ERA5 data, e.g., via interpolation to pressure levels in the vertical dimension and conservative regridding horizontally to a Gaussian grid.

After initial conditions are assigned 124, the system 100 can process the data using a neural general circulation model (GCM) 130. In particular, the neural GCM 130 is a forward model that can process the historical observation data 110 and evolve the weather system iteratively forward in time over a sequence of time steps, e.g., set-length time intervals from the first time defined by the start of a first time step to a final time defined by the end of a final time step. More specifically, the neural GCM 130 can evolve the system by generating a next weather system state autoregressively at each time step from the previous time step.

In an example, the time step size the model 130 uses to evolve the weather system forward in time can be determined by the resolution of the model according to a necessary condition for convergence while solving partial differential equations with a numerical solver, which will be described in more detail below. In particular, the CFL (Courant-Friedrichs-Lewy) condition for horizontal advection, which can vary from hours at coarse resolutions to minutes in higher-resolution settings, can be evaluated to determine the time step size. As an example, the chosen time step length within the sequence of time steps can be 5 minutes, 15 minutes, or one hour.

In the particular example depicted, the neural general circulation model 130 can include one or more tendency calculators 132, which calculate the gradient, e.g., change over time, of the data values that characterize the weather system, and an integrator 134 to integrate the one or more tendencies calculated by the tendency calculators 132 with the current weather system state for that time step. The one or more emulated tendencies can then be integrated at each time step with the weather system state of that time step, e.g., time step t, to produce the next time step's weather state, e.g., t+1, which can be processed autoregressively to generate the following time step's weather state, e.g., the t+2 weather state.

In an example, the neural general circulation model 130 can include an encoder to encode the initial observation 110 from observation-space into an observation representation in model-space that can be used for processing. More specifically, the neural GCM 130 can process the encoded observation representation and can separate the emulation of both dynamical tendencies, e.g., value changes prescribed by the primitive equations, and physical tendencies, e.g., value changes that are not accounted for by the primitive equations, to generate large-scale and small-scale meteorological phenomena, respectively.

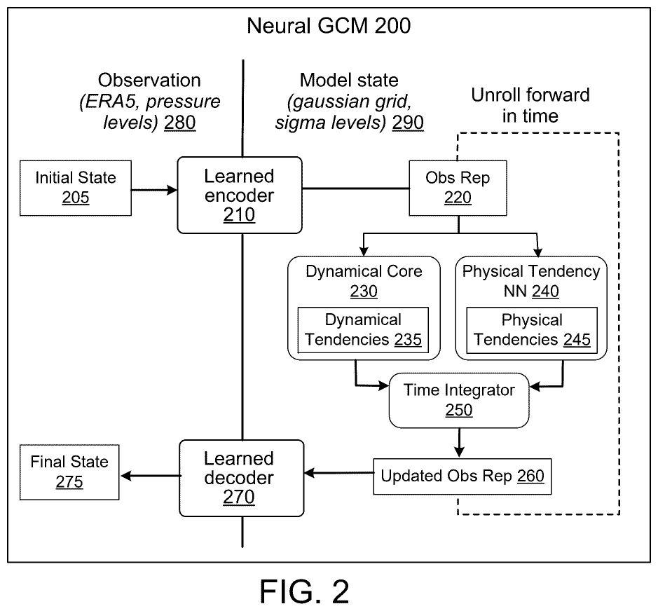

Over a sequence of time steps, the model 130 can calculate one or more dynamical tendencies from the observation representation using a numerical solver and process the observation representation using a physical tendency neural network to generate one or more physical tendencies. In this case, at a final time step, the updated observation representation can be decoded back into observation-space with a decoder, e.g., to generate the predicted future weather observation 160. An example neural GCM 130 that includes an encoder and decoder to encode and decode an observation representation that the numerical dynamical tendency calculator and physical tendency neural network process to evolve the weather system forward in time will be covered in more detail in FIG. 2.

In the case that the neural GCM 130 includes one or more neural networks, the neural GCM 130 neural networks can be any appropriate architecture configured for autoregressive prediction, e.g., a recurrent neural network or transformer.

In some cases, the model 130 can generate the one or more tendencies at a first subset of timesteps at the same cadence, e.g., the tendencies can be calculated at the same time steps within the sequence of time steps. In the particular example of separately calculating dynamical and physical tendencies, both the dynamical and physical tendencies can be calculated every time step or every 3 to 5 time steps.

In another case, the model 130 can generate the one or more tendencies at different cadences where one of the cadences is defined by a second subset of timesteps, e.g., one or more of the tendencies can be calculated at different time steps within the sequence of time steps. In this case, the most recently available tendencies can be integrated together at every time step, e.g., the most recently calculated dynamical and physical tendencies, even if the tendencies were not calculated for the same time step, can be integrated together. The process for integrating one or more tendencies generated at different time steps within the sequence of timesteps will be covered in more detail with respect to FIG. 2.

In the particular example of separately calculating dynamical and physical tendencies, either the dynamical or physical tendencies can be generated separately at a second subset of timesteps without the respective other being calculated at that time step. For example, the dynamical tendencies can be calculated every time step and the physical tendencies can be generated every N time steps, where an example N can be 2, 4, or 10 time steps. The most recently available tendencies can then be integrated together at every time step: for the first subset of time steps in which both the dynamical and physical tendencies are calculated, the most recently available dynamical and physical tendencies come from the current time step and can be integrated together; for the second subset of time steps in which only the dynamical tendencies are calculated, the dynamical tendencies from the current time step and the most recently available physical tendencies can be integrated.

At the final time step of the sequence of time steps, the neural GCM 130 can integrate the one or more final predicted tendencies with the penultimate weather system state to generate the raw future forecast 140. In some examples, the raw future forecast 140 can be generated at a lower resolution than the desired output 160. In this case, the system can process the raw future forecast 140 using a post-processing module 150. As an example, the post-processing can include a rendering model to generate the predicted future weather state 160 at the desired resolution.

The predicted observation future weather state 160 is the forecast of the weather system at a future time. As described above, after being generated by the system 100, the predicted future weather state 160 can be used for different purposes, e.g. for short, medium, or long-range forecasting or for climate prediction, based on how far into the future (with respect to the time associated with the initial state) the future time is.

In some examples, the predicted observation future weather state 160 can also be used to determine a measure of uncertainty for the prediction. More specifically, the observation data 110 that results in the system 100 generating the predicted observation future weather state 160 can be perturbed, e.g., through the application of noise to the observation data 110 characterizing the initial state of the weather system, to produce a perturbed observation. The system can then process the perturbed observation to generate a perturbed observation future weather state and can compare the perturbed observation future weather state with the predicted observation future weather state 160 to quantify a measure of uncertainty for the prediction. In particular, this measure of uncertainty can aid in the understanding and interpretation of the predicted observation future weather state 160, and thereby inform and impact the prediction's use.

FIG. 2 depicts an example neural general circulation model (GCM) that includes separate dynamical and physical tendency calculator components. As an example, the example neural GCM 200 of FIG. 2 can be integrated in a hybrid weather emulation system, e.g., the hybrid weather emulation system 100 of FIG. 1, as the neural general circulation model 130.

In the particular example depicted, the neural GCM 200 can be implemented as a feedforward neural network, e.g., an autoencoder with an encoder-process-decoder architecture. More specifically, the neural GCM 200 can include a learned encoder 210 to process the initial state 205 of the weather system from observation space 280 to generate an encoded observation representation 220 in model space 290. In some examples, the model space 290 can have a smaller dimension than the observation space 280. As an example, the learned encoder 210 can encode the initial state 205 by mapping between the dimension of the observation representation and the dimension of the observation data, e.g., through linearly interpolating and applying an additive learned correction. In some cases, this learned correction can help to mitigate initialization shock, e.g., when the model is initialized out of balance and the model state oscillates rapidly over time, e.g., due to the effects of gravitational waves. As another example, the learned encoder 210 can be any appropriate neural network architecture with a learned set of parameters that perform the mapping from observation to model space.

In some cases, the observation space 280 and model space 290 can have different grid systems. As an example, observation space 280 can include ERA5 or pressure-level coordinates and the model space 290 can include Gaussian grid or sigma-level coordinates 290. More specifically, pressure-level coordinates model the atmosphere on a grid where each vertical level is at a constant pressure level and sigma-level coordinates model the atmosphere on a grid where each vertical level is at a constant fraction of surface pressure.

After mapping into model space 290, the neural GCM 200 can process the observation representation 220 in model space 290 to autoregressively calculate one or more tendencies that describe how the weather system changes over a time step from the most recently available observation representation 220. In the particular example depicted, the neural GCM 200 can autoregressively calculate the dynamical 235 and physical 245 tendencies to evolve the weather system forward in time as described below.

In particular, the observation representation 220 at time t can be processed to calculate the dynamical tendencies 235 and physical tendencies 245 for time t, which can then be integrated with the observation representation for time t 220 using a time integrator 250 to produce the updated observation representation 260 for time t+1. More specifically, the model 200 evolves the weather system forward in time autoregressively, e.g., the updated observation representation 260 for time t+1 can then become the observation representation 220 that can be processed to calculate the dynamical 235 and physical tendencies for time t+1, which can be integrated with the observation representation 220 for t+1, e.g., the previous updated observation representation 260, in order to generate the new updated observation representation 260 for time t+2. This process of iteratively updating the observation representation 220 at every time step advances the weather system forward in time over the sequence of time steps.

In the particular example depicted, the neural general circulation model 200 can calculate dynamical tendencies 235 by numerically solving the primitive equations, which are a set of equations that define the atmosphere's dynamics, using a numerical dynamical tendency calculator, e.g., a dynamical core 230. The primitive equations include nonlinear partial differential equations that describe the flow of fluids and thermodynamics within the atmosphere, such as the continuity, Navier-Stokes, temperature, and specific humidity equations, in a non-inertial, e.g., rotating reference frame. In particular, the primitive equations can be solved using numerical methods, such as finite element or volume methods, spectral methods, or gradient discretization methods, over a discretized grid space of the atmosphere to approximate the intractable solution. In some examples, the dynamical core 230 can combine the numerical method chosen for the solver with spectral filters in order to avoid numerical instabilities in the model.

In the particular example depicted, the neural general circulation model 200 can generate physical tendencies 245 using a physical tendency neural network 240 to generate tendencies that relate to physical phenomena that cannot emerge from numerically solving the primitive equations of the primitive equations alone. For example, this can include phenomena such as clouds, solar radiation, gravity wave drag, and precipitation. In particular, the physical tendency neural network 240 can generate smaller-scale, more localized physical phenomena in a vertical column, e.g., including conditions arising from non-orographic wave drag, shallow and deep convection, long and short-wave radiation, turbulence, and heat flux.

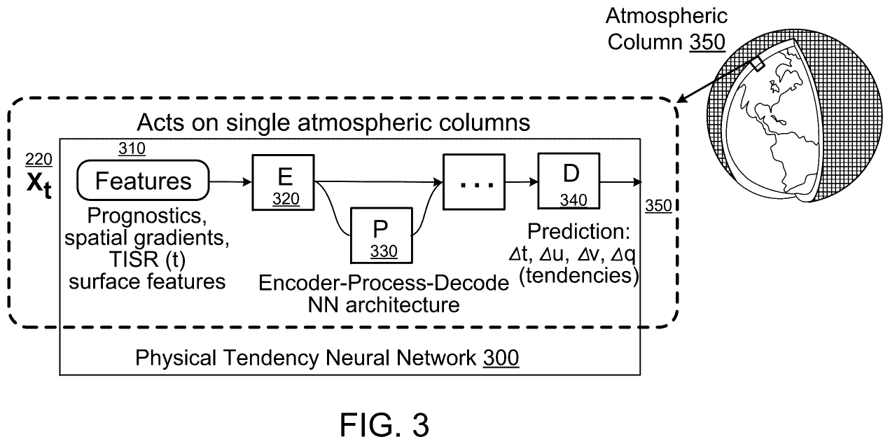

The physical tendency neural network 240 can be implemented with any appropriate neural network architecture that can be configured to process an observation representation 220 to generate physical tendencies 245. As an example, the physical tendency neural network 240 can be implemented as a multi-layer perceptron, transformer, or convolutional neural network. As another example, the physical tendency neural network can be implemented as a feed-forward neural network with an encoder-process-decoder architecture. In particular, an example autoencoder physical tendency neural network 240 will be described in more detail with respect to FIG. 3.

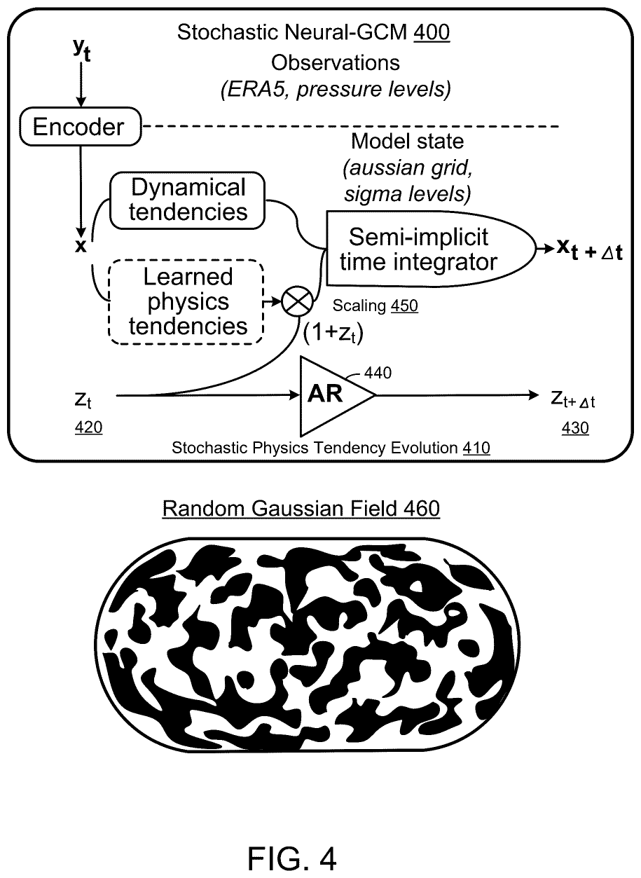

In some implementations, the learned physical tendencies 245 generated by the physical tendency neural network 240 can be combined with an evolving random field in an ensemble method to account for the stochastic nature of the small-scale physical processes the physical tendency neural network 240 is predicting. More specifically, the physical tendencies 245 can be scaled according to a random field before being integrated with the dynamical tendencies 235 and the observation representation 220. An example ensemble method that applies a random Gaussian field scaling to the physical tendencies 245 will be covered in FIG. 4.

The model 200 can use a time integrator 250 to integrate, e.g., accumulate the input quantities over a time step in order to produce an output, the dynamical 235 and learned physical tendencies 245 with the most recently available observation representation 220 to advance the weather system forward in model space 290. As an example, the model can use a semi-implicit time integrator, e.g., a time integrator that treats selected linear terms implicitly and the remaining terms explicitly in order to maintain the numerical stability of the calculation, such as an Implicit-Explicit Runge-Kutta time stepper. As another example, the model can integrate the dynamical 235 and physical 245 tendencies using a multiple time-level ODE solver, such as a Leapfrog, Backward-Differentiation-Formulas, or Adams-Bashforth method.

As mentioned in FIG. 1, in some examples, the neural GCM model 200 can support reusing either the calculated dynamical tendencies 235 or generated physical tendencies 245 across several time steps to reduce computational cost during training and inference. In particular, the dynamical tendencies 235 can be calculated at a second subset of time steps, e.g., every M time steps using the dynamical core 230 and the physical tendencies 245 can be generated using the physical tendency neural network 240 at a first subset of time steps in which both the dynamical and physical tendencies are calculated, e.g., every N time steps, alongside the dynamical tendencies 235. As an example, N can be a multiple of M. In this case, the time integrator 250 can integrate the most recently available dynamical and physical tendencies at every time step.

For example, the dynamical tendencies 235 can be calculated every time step and the physical tendencies 245 can be generated every three time steps. In this case, the updated observation representation 260 can be generated at each time step by integrating the most recently available dynamical tendencies 235, e.g., the dynamical tendencies from the current time step, with the most recently available physical tendencies 245, e.g., the physical tendencies generated from two or less time steps ago (with respect to the current time step). In particular, the dynamical tendencies 235 from time t can be integrated with the physical tendencies 245 from time t, the dynamical tendencies 235 from time t+1 can be integrated with the physical tendencies 245 from time t, and the dynamical tendencies 235 from t+2 can be integrated with the physical tendencies 245 from time t to generate the updated observation representation 260 for time t, t+1, and t+2, respectively.

The model 200 continues to evolve the weather system forward in time in model space 290 by iteratively updating the observation representation 260 over the sequence of time steps. After the final time step of evolution is complete, the model 200 generates the final updated observation representation 260, which represents the predicted future state of the weather system in model space 290. The final updated observation representation 260 can then be decoded by a learned decoder 270 to generate the final state 275 of the weather system in the observation space 280.

In particular, the learned decoder 270 can undo the mapping between the observation space 280 and the model space 290 performed by the learned encoder 210. In the case that the encoder 210 performs a linear interpolation with an additive learned correction, the decoder 270 can decode the updated observation representation 260 by linearly interpolating between the dimension of the model space 290 and the dimension of the observation space 280 and applying an additive learned correction to cancel out the encoder's learned correction. As another example, the decoder 270 can be any appropriate neural network architecture with a learned set of parameters that perform the mapping from model 280 to observation space 290. The final state 275 can then be optionally post-processed (e.g., using the post-processing module 150 of FIG. 1) to form the predicted future weather state (e.g., the predicted future weather state 160 of FIG. 1).

FIG. 3 depicts an example physical tendency neural network, e.g., a specific implementation of physical tendency neural network 240 of FIG. 2. In this case, the physical tendency neural network 300 is an autoencoder trained to generate predicted physical tendencies 245 using an encoder-process-decoder architecture.

In some cases, the physical tendency neural network 240 can be parametrized to process the input over a different grid system than the observation representation 220. In the particular example depicted, the physical tendency neural network 300 processes data and generates physical tendency predictions 245 for atmospheric columns 350. More specifically, parametrizing the neural network model 300 in this way localizes the generated predictions such that the neural network 300 cannot violate geographic-causality.

In particular, explicitly restricting the physical tendency neural network 300 to generate predictions in a localized region, e.g., an atmospheric column 350, can help overcome the drawback of a pure machine learning approach that can learn to generate nonphysical phenomena. For example, a machine learning weather prediction model that is not geographically restricted can learn to associate warmer sea surface temperatures in one location directly with increased precipitation in another location without requiring the water to evaporate and be transported to the other location in the form of water vapor or clouds. More specifically, there is no guarantee that the result of a geographically-unrestricted model can satisfy the conservation of mass, energy, or momentum inherent in a physical system.

In the case that the physical tendency neural network 300 processes the input over a different grid-system than the observation representation, the neural network 300 can first process the observation representation 220, e.g., the observation representation of the initial state of the weather system in model space 290, using a feature extraction process to generate a set of one or more features 310 in the different grid-system. As an example, the physical tendency neural network 300 can perform feature extraction from the observation representation 220 to generate one or more of: prognostic variables—e.g., temperature, specific humidity, divergence, vorticity, and specific cloud ice and liquid water, diagnostic variables—e.g., potential temperature data, static surface features, horizontal and vertical transport velocity, and relative humidity—e.g., elevation, land or sea indicator functions, soil type, longitude, and latitude data and dynamic inputs such as spatial gradients, e.g., the first and higher order derivatives of the horizontal and vertical velocity components.

In particular, the observation representation 220 can be processed using feature extraction to distill the observation representation 220 into the most relevant features already present in and to create derivative features from the observation representation 220 within atmospheric vertical columns 350 in order to create the vertical column input to the encoder block 320 of the model. The physical tendency neural network 300 can then process data representing atmospheric columns 350 at the current time step in order to generate the predicted physical tendencies in the atmospheric columns at the current time step that can then be integrated with the dynamical tendencies to advance the state of the weather system in model space 290.

In the particular example depicted, the physical tendency neural network is implemented as a feedforward neural network with an encoder-process-decoder architecture that can process the features 310 within a single atmospheric column 350 for each atmospheric column in the weather system to generate the predicted physical tendencies 245 for that column. More specifically, the physical tendency neural network 300 can encode 320 the features 310 into a different-dimensioned latent space, process 330 the features within the latent space, and decode 330 after processing to generate the predicted physical tendencies 350 within each atmospheric column 350. As an example, the predicted physical tendencies 350 can include the temperature, horizontal transport velocity, vertical transport velocity, and specific humidity gradients within each atmospheric column 350.

In some cases, the physical tendencies generated by the physical tendency neural network, e.g., the physical tendency neural network 240 of FIG. 2, can be combined with a stochastic component, e.g., stochastic physics tendencies, to further account for the stochastic nature of weather predictions in an ensemble method. FIG. 4 depicts an example implementation of a stochastic neural general circulation model. As an example, the example stochastic neural GCM 400 of FIG. 4 can be integrated in a hybrid weather emulation system, e.g., the hybrid weather emulation system 100 of FIG. 1, as the neural general circulation model 130.

In some cases, the stochastic neural GCM 400 incorporates a scaling 450 that is applied to the generated physical tendencies, e.g., the physical tendencies 245 of FIG. 2, to introduce a level of stochasticity or randomness to the physical tendencies 245. As an example, the scaling 450 can be derived from an evolving random field, e.g., a random field that evolves in accordance with each time step of the sequence of weather state evolution time steps.

The evolving random field that represents the stochastic physics tendencies can be initialized at an initial state zₜ 420 and evolved forward in time at each time step or at certain multiples of time steps using an autoregressive (AR) stochastic physics tendency evolution method 440, e.g., a set of one or more equations that prescribe the evolution of the random field. More specifically, evolving the random field can produce the stochastic physics tendencies at the next time step z_{t+Δt} 430.

As an example, the random field that can be evolved to generate stochastic physics tendencies via stochastic physics tendency evolution 410 can be a random Gaussian field 460 initialized over the same geographic region as the weather system. In the particular example depicted, the weather system is the earth, so the random field is initialized and evolved over the entire earth. In other examples, the weather system can be a localized geographic region. In this case, the random field can be initialized and evolved in the geographic coordinates that pertain to the localized region of the weather system.

More specifically, the random field, e.g., the random Gaussian field 460, can be used to scale the physical tendencies 245 at each time step using the scaling 450. In an example, the scaling 420 can involve multiplying the one or more generated physical tendencies 245 by a factor of 1+z, where z represents the most recently available stochastic physics tendencies 430 generated through stochastic physics tendency evolution 410 at that time step. In another example, the scaling can involve a more complicated function of the stochastic physics tendencies 230 for the current time step 430, e.g., an exponential, logarithmic, sinusoidal, etc. function of the stochastic physics tendencies.

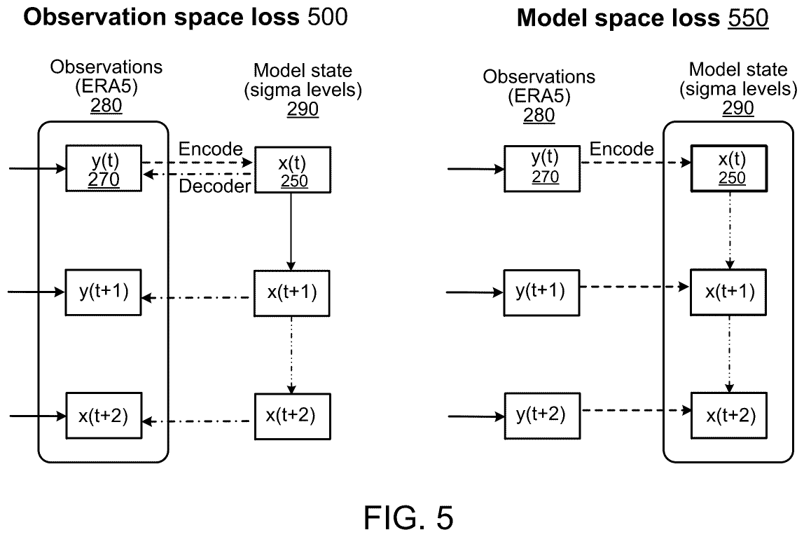

FIG. 5 depicts two example loss schemes that can be used to train the neural general circulation model, e.g., the neural GCM 130 of FIG. 1, by tracking the evolution of the weather state system at each time step within the sequence of time steps in either or both of the observation and model spaces, e.g., the observation space 280 and the model space 290 of FIG. 2. In particular, the loss function can incorporate one or more terms from either the example observation space loss scheme 500 or model space loss scheme 550 to train the neural general circulation model 130 on a variety of physics-based losses, which will be described below.

More specifically, one or more physics-inspired loss functions can be calculated in either observation 280, model 290, or both spaces with respect to a ground truth observation space or model space state. Combining losses from both observation 280 and model space 290 can result in a more robust training process by evaluating the model evolution in both spaces. In particular, applying loss terms to ensure accuracy in both observation 280 and model space 290 can help ensure that the model representation in both spaces remains consistent over time.

As an example, the neural GCM 130 can be trained to match a global reanalysis, e.g., the ERA5 dataset. In this case, the model 130 can evolve the state of a historical weather system forward in time, e.g., forward in time in the past, and evaluate the evolving state of the weather system in either observation 280 or model 290 space at each time step against a “future” state with respect to the previous historical state of the past. In the particular example depicted and discussed, the ERA5 dataset is represented and referred to as the ground truth data in the observation space 280. In other examples, different datasets can be used, including datasets derived from simulation, as the ground truth.

The observation loss 500 is calculated in observation space 280 and the model loss 550 is calculated in model space 290. In some cases, the observation loss 500 can be calculated with respect to the ERA5 dataset observations directly. In the case that the neural GCM 130 processes input data with a different grid system than ERA5, the ERA5 observations can be regridded, e.g., via interpolation to pressure levels in the vertical dimension and to a Gaussian grid in the horizontal dimension, before being used as ground truth to allow for proper comparison. In the model space 290, the ground truth can be generated by encoding the ERA5 ground truth observation with the same encoder, e.g., the learned encoder 210, used to encode the observation representation, e.g., the observation representation 220, of the model in model space 290.

In particular, the observation space loss 500 can include calculating the loss at each time step in observation space 280 at every time step of model evolution with respect to a ground truth observation in observation space 280. More specifically, calculating the loss in observation space 280 from the updated observation representation 260 involves decoding the weather state of the updated observation representation 260 from model space 290, e.g., with the learned decoder 270 of FIG. 2, at each time step to compare the decoded observation with a ground truth observation at each time step. At every time step, decoding the observation representation 260 back into observation space 280 provides a notion of how the model is evolving the weather system state in observation space 280 and can be used to track the evolution of the weather system state in observation space 280.

Likewise, the model space loss 500 can include calculating the loss at each time step in model space 290 at every time step of model evolution with respect to a ground truth observation in model space 290. More specifically, calculating the loss in model space 290 from the updated observation representation 260 can involve encoding the weather state of the weather system from model space 290, e.g., with the learned encoder 210 of FIG. 2, at each time step to compare the encoded ground truth observation with the updated observation representation 260 at each time step. At every time step, encoding the observation into model space 290 provides a notion of how the model is evolving the weather system state in model space 290 and can be used to track the evolution of the weather system state in model space 290.

As an example, the model can be trained using stochastic gradient descent in an end-to-end setting to minimize discrepancies between target historic weather data and model predictions in both observation space 280 and model space 290. A combination of losses can be calculated relating to accuracy, consistency, and biases in either observation 280, model 290, or both spaces.

In particular, the losses described below can be calculated at varying lead-times, e.g., the length of time between the initialization of the forecast and the time of the final observation. Additionally, each loss term can be computed either based on spectral, e.g., spherical harmonic, or nodal, e.g., longitude-latitude basis. As an example, losses can be calculated in the spectral basis to penalize bias as a function of total and zonal wavenumber.

As an example, the accuracy of the model can be improved through minimizing lead-time filtered mean squared loss. This loss function adds mean squared filtered errors to the loss, where one or more different filters progressively remove components with higher spatial frequencies at longer lead-times, a modification that avoids the double penalty of predicting physically expected features in wrong places at the wrong times when an exact match cannot be expected due to the chaotic nature of the weather. In this case, the relevant lead-time timescales can be estimated using the rate of error growth in current operational numerical weather prediction models for each wavelength.

As another example, consistency can be encouraged by mean squared loss on the total wavenumber spectrum of the predicted weather fields. In particular, this loss can encourage the model to predict features that have correct spectral distribution without penalizing prediction of slightly perturbed spatial features. As yet another example, mean squared error on the mean amplitude of each spherical harmonic coefficient can be calculated to discourage bias.

At the end of each training step, the system can calculate the losses and backpropagate the gradients of the loss function to update the weights of the neural GCM 130, and, in particular, the physical tendency neural network, using an optimizer. As an example, the Adam optimizer can be used to update the weights of the neural GCM 130.

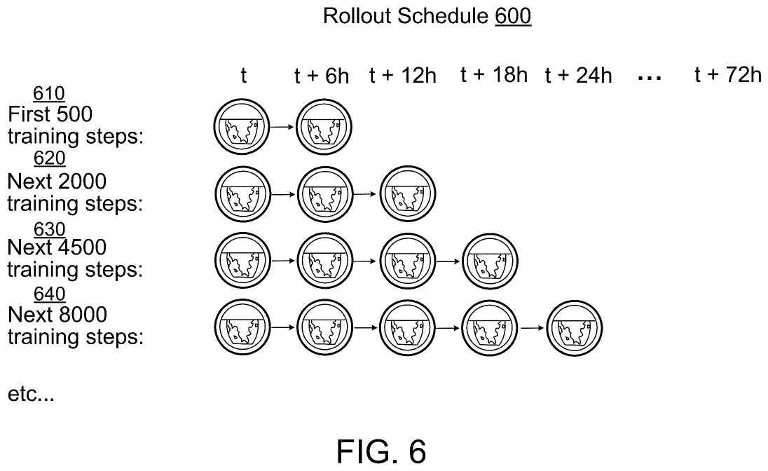

FIG. 6 depicts an example training technique for increasing rollout length, i.e., the length of time that elapses in model evolution over the course of a training step, while training the neural general circulation model, e.g., the neural GCM 130 of FIG. 2.

A training step can consist of one or more model evolution time steps. In particular, losses can be computed on progressively longer training steps to assess longer feedback loops between the dynamical core, e.g., the dynamical core 230, and the physical tendency neural network, e.g., the physical tendency neural network 240. More specifically, shorter feedback loops can be assessed as the model begins training to ensure computational resources are not wasted by the evolution deviating far from the ground truth, and the length of the rollout can be increased such that longer feedback loops can be assessed as the model progressively learns and makes more accurate predictions of future weather states. As an example, the rollout can start at 6 or 12 hours and gradually increase to 3 or 5 days. As another example, rollout can start at one or two days and gradually increase to one or two weeks.

In the particular example depicted, the rollout schedule 600, which defines the lengthening of the rollout over the course of training, depends on the time elapsed according to the interval length of the time steps within the sequence of time steps. The rollout schedule 600 can be implemented by a hybrid weather emulation system, e.g., the hybrid weather emulation system 100 of FIG. 1, when training the neural GCM 130. In the example rollout schedule 600 depicted, the first 500 training step iterations 610 happen every t+6, the next 2000 iterations 620 happen every t+12 hours, the next 4500 iterations 630 happen every t+18, and the next 8000 iterations 640 happen every t+24 hours, where t=0 defines the start of the first step of model evolution.

In other examples, the rollout schedule 600 can depend on the accuracy achieved by the model 130. In particular, the system 100 can increase the length of training as the model 130 achieves certain performance milestones, e.g., accuracy thresholds, during training. For example, when the loss evaluated for a training step crosses a lower bound in line with a certain accuracy, the system 100 can increase the number of iterations that the model 130 is allowed to evolve the system before training is next required.

In some cases, increasing rollout with respect to performance milestones can be implemented as a rules-based system, as described above. In other cases, the milestones can be adaptively generated using a statistical model or machine learning approach.

Implementing a rollout schedule 600 over increasingly long rollouts can reduce compute time and save resources during training. In particular, training every model evolution time step would be the most computationally intensive way of training the model 130, and training with the longest reasonable rollout would be the least computationally intensive. The longest reasonable rollout can be defined with respect to the model learning process, e.g., the model 130 cannot begin to learn without being evaluated at a more frequent cadence at first to correct the model's 130 earliest mistakes. Increasing the length of rollout over the course of training ensures the neural GCM 130 can begin to learn and then increases the efficiency of the training process by reducing the compute needed to continue learning.

FIG. 7 demonstrates the results of an example neural GCM model, in particular, the neural GCM model 200 of FIG. 2, trained with the techniques detailed in FIGS. 5 and 6 at different resolutions. In particular, the results illustrate the impact of the horizontal and vertical grid resolutions chosen during the data processing stage (e.g., the data processing stage 120 of FIG. 1).

The results depicted are for a Gaussian grid defined over 2.8 degrees 700, 1.4 degrees 720, and 0.7 degrees 740 latitude, respectively. More specifically, the 2.8 degree grid system has 64 latitude nodes and 128 longitude nodes, the 1.4 degree grid system has 128 latitude nodes and 256 longitude nodes, and the 0.7 degree grid system has 256 latitude nodes and 512 longitude nodes. Additionally, an example ground truth defined by ERA5 reanalysis data 760 that the trained model seeks to emulate is depicted.

The results demonstrate how models trained at higher resolutions perform better, e.g. provide more precise model evolution, than models trained at lower resolutions. In particular, the 0.7 degree model 740 replicates the ground truth ERA5 reanalysis data 760 with high fidelity.

However, training at a higher resolution demands more computational resources, because of the larger number of grid points modeled in space and time. For example, a model with 1.4 degree resolution requires approximately eight times as many grid points as a model with 2.8 degree resolution, because twice as many grid points are required in latitude, longitude, and time.

In particular, the neural GCM 200 can be run with a coarser grid system to reduce the computational resources necessary for training and inference, at the cost of reduced precision. More specifically, while the overall trends of the ground truth ERA5 data 760 are visible in the lower resolution models at 2.8 degrees 700 and 1.4 degrees 720, respectively, the finer details of the weather system cannot be resolved at these scales. In the case that the intended use case of the final observation does not require high resolution, the system can reduce the use of computational resources by training and generating results at lower resolutions.

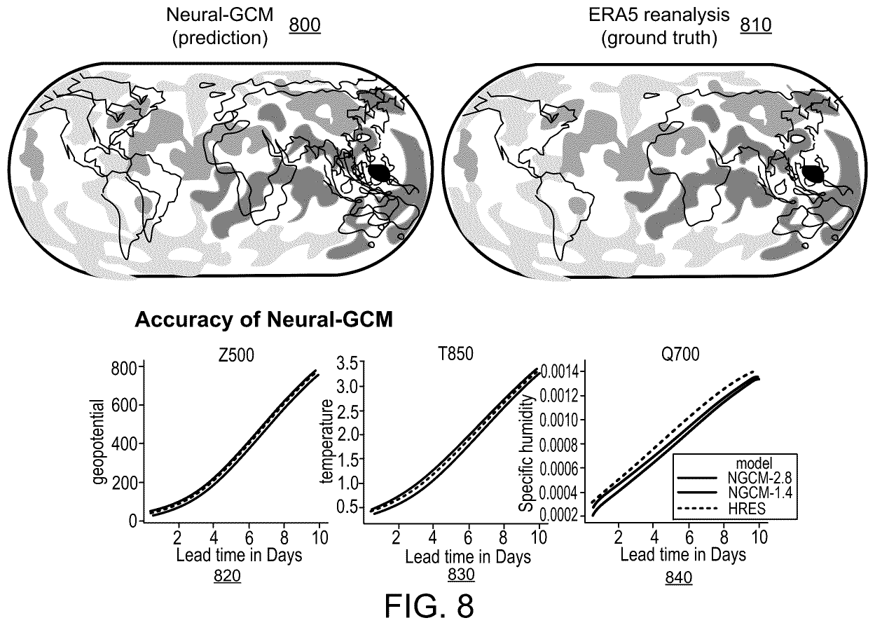

FIG. 8 illustrates the accuracy of an example neural GCM model, in particular, the neural GCM model 200 of FIG. 2, trained with the techniques detailed in FIGS. 5 and 6.

In particular, FIG. 8 depicts the specific humidity results of the model 200 trained with the techniques described over a weather system of the whole earth as compared to the ground truth of the ERA5 dataset. Notably, the neural GCM prediction 800 matches the ERA5 reanimation 810 with high fidelity at level 850 kPa over a five day period when trained with five prognostic variables, e.g., temperature, geopotential, two components of horizontal wind velocity, specific humidity, and 37 pressure levels in a full atmospheric state. More specifically, the 37 pressure levels indicates that the model generates the five prognostic variables at 37 heights over each three-dimensional box defined by the chosen grid resolution. As an additional example, the prognostic variables can include specific cloud water and specific cloud ice.

Furthermore, the model can achieve competitive accuracy across geopotential, i.e., the height of a pressure surface, temperature, and specific humidity 840 variables, as depicted in plots 820, 840, and 860. The plots 820, 840, and 860 also demonstrate how the accuracy of the model increases when run at higher-resolution.

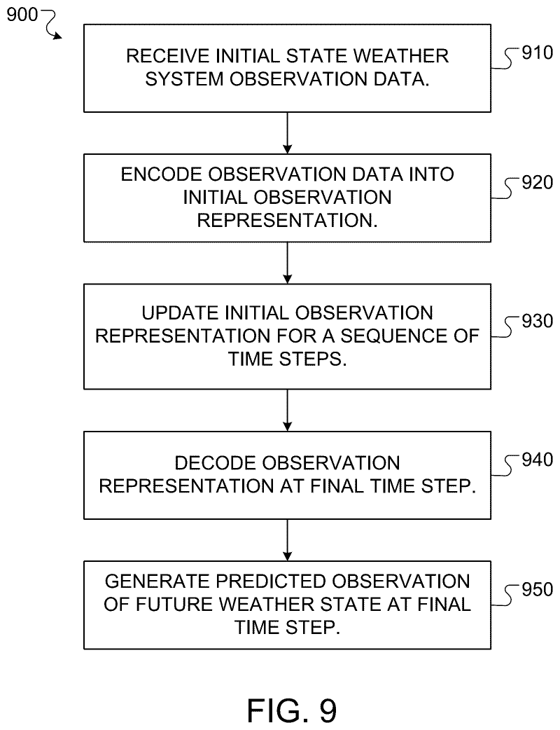

FIG. 9 is a flow chart of an example process for receiving initial state weather system observation data, processing the data iteratively, and generating a predicted observation of a future weather state. For convenience, the process 900 will be described as being performed by a system of one or more computers located in one or more locations. For example, a hybrid weather emulation system, e.g., the hybrid weather emulation system 100 of FIG. 1, appropriately programmed in accordance with this specification, can perform the process 900.

In particular, the system can receive initial state weather system observation data (step 910). As an example, the initial observation data can come from a preprocessed dataset or be a raw data observation that can be processed by a preprocessing module, e.g., the preprocessing module 120 of FIG. 1. In particular, the observation data can be preprocessed to be discretized in a particular grid-system in observation space. Then, the observation data can be encoded into an observation representation in model space (step 920). As an example, the encoding can involve linear interpolation with a learned correction. In some cases, this learned correction can help to mitigate initialization shock, e.g., when the model state oscillates rapidly due to gravitational waves.

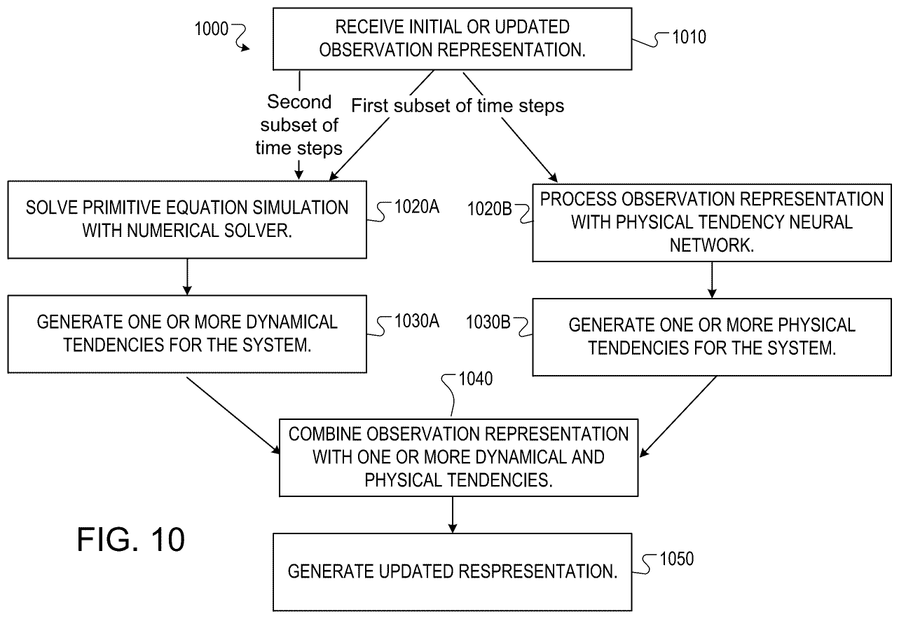

The system can then update the initial observation representation for a sequence of time steps (step 930). In particular, the sequence of time steps can evolve the initial weather state forward from the first time step of the sequence to a final time step. As an example, the final time step can be one hour or one day in the future, in which case the final time step updated observation representation provides a short-range weather forecast. As another example, the final time step can be one week or 20 days in the future, in which case the final time step updated observation representation provides a medium-range weather forecast. As a further example, the final time step can be three months, six months, or one year in the future, in which case the final time step updated observation representation provides a long-range weather forecast. As yet another example, the final time step can be 10 years, 20 years, or 200 years in the future, in which case the final time step updated observation representation provides a climate prediction. An example process for updating the initial observation representation iteratively using a neural general circulation model will be described in more detail in FIG. 10.

At the final time step, the updated observation representation can be decoded back into observation space (step 1040). In a particular example, the decoding can involve linear interpolation with a learned correction using a decoder back into observation space. Thus, the system generates a predicted observation of future weather state at a final time step (step 950).

FIG. 10 is a flow chart of an example process for iteratively updating the observation to evolve the weather state forward in time. For convenience, the process 1000 will be described as being performed by a system of one or more computers located in one or more locations. For example, a hybrid weather emulation system, e.g., the hybrid weather emulation system 100 of FIG. 1, appropriately programmed in accordance with this specification, can perform the process 1000 to iteratively update the observation representation.

In particular, the system can receive the initial observation representation (step 1010). In some examples, the initial observation representation can be encoded into a model space that is of a different-dimension than the original observation space. Then, for a first subset of time steps, the system can solve for one or more tendencies, e.g., gradients defining how data values of the weather system change over a time step. More specifically, the system can solve a primitive equation simulation with a numerical solver (step 1020A), e.g., the dynamical core 230 of FIG. 2, and can process the observation representation with a physical tendency neural network (step 1020B), e.g., the physical tendency neural network 240 of FIG. 2.

The system can then generate one or more dynamical tendencies for the system (step 1030A) and one or more physical tendencies for the system (step 1030B). As an example, the dynamical tendencies can include the horizontal and vertical transport velocities, specific humidity, temperature, and vorticity; and the physical tendencies can include non-orographic wave drag, shallow and deep convection, long and short-wave radiation, turbulence, and heat flux.

For a second subset of time steps, the system can solve a primitive equation simulation with a numerical solver (step 1020A), e.g., the dynamical core 230 of FIG. 2 to generate one or more dynamical tendencies for the system (step 1030A). The system can then combine the most recently available observation representation with one or more most recently available dynamical and physical tendencies (step 1040) to generate the updated observation representation for the current time step (step 1050). For example, in a case where the dynamical and physical tendencies are calculated in a first subset of timesteps representing every N time steps and the dynamical tendencies are calculated in a second subset of timesteps representing every M time steps, the most recent dynamical tendencies can come from up to t−M−1 steps previously and the most recent physical tendencies can come from up to t−N−1 steps previously.

The system can repeat process 1000 iteratively from the first time step in the sequence of time steps to the final time step in the sequence. More specifically, the updated observation representation of step 1050 can be generated for time t and used to calculate the dynamical and physical tendencies of the next time step t+1, such that the system can integrate the dynamical and physical tendencies with the previously most recent updated observation representation to generate the next updated representation for t+2, etc. to evolve the weather system forward in time. At the final time step in the sequence of time steps, the updated observation representation can be decoded, as discussed in FIG. 9, to generate the predicted observation of the future weather state.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, or a Jax framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method for forecasting future states of a weather system comprising:
receiving observation data characterizing an initial state of a weather system at a first time step;
encoding the observation data to generate an observation representation for the first time step;
updating the observation representation for each of a sequence of time steps, the updating comprising, for each time step in a first subset of the time steps:
calculating, from the observation representation and using a numerical solver that solves the primitive equations of the atmosphere, one or more dynamical tendencies for the weather system;
processing an input comprising the observation representation using a physical tendency neural network to generate one or more physical tendencies for the weather system;
combining the observation representation with the one or more dynamical and physical tendencies to update the observation; and
decoding the observation representation at a final time step in the sequence to generate a predicted observation of a future weather state at the final time step.

2. The method of claim 1, wherein the one or more dynamical and physical tendencies each represent a gradient over a duration of a time step of a corresponding physical value of the weather system.

3. The method of claim 2, wherein the corresponding physical value of the weather system comprises one or more of a temperature, specific humidity value, horizontal transport velocity, and vertical transport velocity.

4. The method of claim 1, wherein, at each time step in a second subset of the time steps:
calculating, from the observation representation and using a numerical solver that solves the primitive equations of the atmosphere, one or more dynamical tendencies for the weather system;
obtaining one or more most recently generated physical tendencies from the most recent time step in the second subset of time steps; and
combining the observation representation with the one or more dynamical and the most recently generated physical tendencies to update the observation representation.

5. The method of claim 1, wherein the observation data characterizing an initial state of a weather system comprises one or more of prognostic variables, diagnostic variables, static surface features, and prescribed dynamic inputs.

6. The method of claim 1, wherein the observation data further comprises sea surface temperature, albedo, and incident solar radiation.

7. The method of claim 1, wherein encoding the observation data comprises:
linearly interpolating between the dimension of the observation data and the dimension of the observation representation; and
applying an additive learned correction.

8. The method of claim 1, wherein decoding the observation representation comprises:
linearly interpolating between the dimension of the next time step observation representation and the dimension of the observation data; and
applying an additive learned correction.

9. The method of claim 1, wherein the observation data is discretized in accordance with a discretization method to yield a grid system of horizontal and vertical coordinates at a specific resolution over the weather system.

10. The method of claim 11, wherein the discretization method is a pseudo-spectral spatial discretization method on a Gaussian grid with a sigma coordinate system.

11. The method of claim 1, wherein using a numerical solver that solves the primitive equations of the atmosphere comprises numerically solving fluid dynamics and thermodynamics equations on the surface of a rotating sphere.

12. The method of claim 1, wherein using the physical tendency neural network to generate one or more physical tendencies comprises:
generating one or more features from the observation representation;
processing an input comprising the one or more features using a physical tendency encoder neural network to generate respective vertical coordinate features for each of a plurality of vertical columns;
processing the vertical coordinate features for each vertical column to generate processed features for the vertical column; and
decoding the processed features for each of the vertical columns into output tendencies for each vertical column using a physical tendency decoder neural network.

13. The method of claim 1, wherein generating the physical tendencies further comprises scaling the output tendencies to a standard deviation of target physical tendencies evaluated from historical weather data.

14. The method of claim 1, wherein generating the physical tendencies further comprises scaling the output tendencies by an evolving random field.

15. The method of claim 16, wherein the evolving random field evolves at each time step.

16. The method of claim 14, wherein the output tendencies for each vertical column comprise one or more of values that distinguish transient weather effects within the vertical column.

17. The method of claim 18, wherein the transient weather effects within the vertical column comprise clouds, solar radiation, gravity wave drag, and precipitation.

18. The method of claim 1, wherein combining the observation representation with the one or more dynamical and physical tendencies at each time step comprises:
integrating the one or more dynamical and physical tendencies using a time step integrator to generate integrated tendencies; and
applying the values of change specified by the integrated tendencies to the observation representation.

19. The method of claim 18, wherein the time integrator is a semi-implicit or implicit-explicit Runge Kutta time stepper.

20. The method of claim 1, wherein the physical tendency neural network has been trained with one or more physics-inspired losses to minimize discrepancies between predicted next observation states and reference historic weather data.

21. The method of claim 22, wherein computing the one or more physics-inspired loss terms comprises computing losses in one or more of a spherical-harmonic or longitude-latitude basis.

22. The method of claim 23, wherein computing the one or more loss terms involves computing loss terms in observation space and in a model space defined by vertical columns, wherein the vertical columns are associated with respective output tendencies.

23. The method of claim 24, wherein a duration interval between each time step in the sequence of time steps evolves in length over the course of training.

24. The method of claim 25, wherein the duration interval between each time step begins at six hours and evolves to three days over the course of training.

25. The method of claim 1, further comprising determining a measure of uncertainty for the first predicted observation of the future weather state generated from the first initial state of a weather system, wherein:
applying noise to the observation data characterizing the first initial state of a weather system to produce a second initial state;
generating a second observation of the future weather state at the final time step from the second initial state;
determining a measure of uncertainty of the future weather state by comparing the first predicted observation and the second predicted observation.

26. A system comprising one or more computers and one or more storage devices storing instructions that are operable, when executed by the one or more computers, to cause the one or more computers to perform operations comprising:
receiving observation data characterizing an initial state of a weather system at a first time step;
encoding the observation data to generate an observation representation for the first time step;
updating the observation representation for each of a sequence of time steps, the updating comprising, for each time step in a first subset of the time steps:
calculating, from the observation representation and using a numerical solver that solves the primitive equations of the atmosphere, one or more dynamical tendencies for the weather system;
processing an input comprising the observation representation using a physical tendency neural network to generate one or more physical tendencies for the weather system;
combining the observation representation with the one or more dynamical and physical tendencies to update the observation; and
decoding the observation representation at a final time step in the sequence to generate a predicted observation of a future weather state at the final time step.

27. A computer storage medium encoded with a computer program, the program comprising instructions that are operable, when executed by data processing apparatus, to cause the data processing apparatus to perform operations comprising:
receiving observation data characterizing an initial state of a weather system at a first time step;
encoding the observation data to generate an observation representation for the first time step;
updating the observation representation for each of a sequence of time steps, the updating comprising, for each time step in a first subset of the time steps:
calculating, from the observation representation and using a numerical solver that solves the primitive equations of the atmosphere, one or more dynamical tendencies for the weather system;
processing an input comprising the observation representation using a physical tendency neural network to generate one or more physical tendencies for the weather system;
combining the observation representation with the one or more dynamical and physical tendencies to update the observation; and
decoding the observation representation at a final time step in the sequence to generate a predicted observation of a future weather state at the final time step.
